(19) United States
(12) Patent Application Publication
(10) Pub. No.: US 2011/0151809 A1
(43) Pub. Date: Jun. 23, 2011

(54) APPARATUS AND METHOD FOR ANALYZING CHANNEL USING TRANSMITTER IDENTIFICATION SIGNAL

(75) Inventors: Hyoungsoo LIM, Daejeon (KR); Heung Mook KIM, Daejeon (KR)

(73) Assignee: Electronics and Telecommunication Research Institute, Daejeon (KR)

(21) Appl. No.: 12/852,888

(22) Filed: Aug. 9, 2010

(30) Foreign Application Priority Data
Dec. 21, 2009 (KR) 10-2009-0128230

(51) Int. Cl. H04B 17/00

(52) U.S. Cl. 455/115.1

(57) ABSTRACT

Provided is a channel analysis apparatus and method using a transmitter identification signal. The channel analysis apparatus using the transmitter identification signal may include a reference signal generating unit to generate a reference signal, a correlation unit to correlate a received signal and the reference signal to calculate a correlation value, an interpolation unit to interpolate the calculated correlation value, and an analysis unit to analyze the received signal using the interpolated correlation value.

### CROSS-REFERENCE TO RELATED APPLICATION

This application claims the benefit of Korean Patent Application No. 10-2009-0128230, filed on Dec. 21, 2009, in the Korean Intellectual Property Office, the disclosure of which is incorporated herein by reference.

### BACKGROUND

1. Field of the Invention

The present invention relates to a channel analyzing apparatus and method using a transmitter identification signal, and more particularly, to a channel analyzing apparatus and method using a transmitter identification signal, which may interpolate a correlation value between a received signal and a reference signal to improve an accuracy in detecting a feature of the received signal.

2. Description of the Related Art

In a recent digital broadcast system standard, a base station transmitter or a relay station may transmit a unique identification signal and thus, a feature of each signal transmitted from the transmitter or the relay station among signals received by a receiving apparatus may be detected and identified. For example, according to an advanced television systems committee (ATSC) standard, the base station transmitter or the relay station may modulate a Kasami sequence to have a sufficiently low power compared with an original broadcast signal, and may add the modulated Kasami sequence to the original broadcast signal and may then perform transmission.

FIG. 1 illustrates a configuration of a conventional transmitter identification signal analyzing apparatus 101.

Referring to FIG. 1, the conventional transmitter identification signal analyzing apparatus 101 may include a reference signal generating unit 103, a correlation unit 105, and an analysis unit 107.

The correlation unit 105 may receive a transmitter identification signal from a transmitter 109. The correlation unit 105 may correlate a reference signal generated by the reference signal generating unit 103 and a received signal to calculate a correlation value.

The analysis unit 107 may detect a feature of the received signal by analyzing the received signal based on the correlation value.

FIG. 2 illustrates a correlation output signal generated when a synchronization error does not exist in a conventional transmitter identification signal, and FIG. 3 illustrates a magnified peak of FIG. 2.

Referring to FIGS. 2 and 3, a dotted curve 301 indicates a theoretical correlation feature, a point 303 connected to a line indicates a discrete correlation value based on a time interval where a transmitter identification signal analysis apparatus calculates a correlation value.

The conventional transmitter identification signal analysis apparatus may correlate a received signal and a reference signal based on a length of vestigial side band (VSB) symbol or based on a sampling interval of a receiving apparatus.

The conventional transmitter identification signal analysis apparatus may determine a signal, as illustrated in FIG. 3, when a synchronization error is not incurred, which is an ideal condition. However, a timing of the transmitter identification signal analysis apparatus may not synchronize with a timing of a received transmitter identification signal due to a reception timing difference between the received signal and a ghost signal based on a multi-path or a reception timing difference between the received signal and an adjacent transmitter identification signal.

For example, the conventional transmitter identification signal analysis apparatus may determine a correlation output signal, as illustrated in FIG. 4, when a synchronization error is incurred. In this case, the conventional transmitter identification signal analysis apparatus may not accurately estimate the timing, a power, and a phase of the received signal.

Therefore, there is a desire for a transmitter identification signal analysis apparatus that may accurately analyze a feature of a signal received in a different timing from a VSB symbol timing or from a sampling timing.

### SUMMARY

An aspect of the present invention provides a channel analysis apparatus and method using a transmitter identification signal, which may calculate a correlation value by correlating a received signal and a reference signal, and may accurately analyze a feature of a received signal, using a maximum correlation value among adjacent correlation values and a timing of the maximum correlation value, even when a synchronization error is incurred.

According to an aspect of the present invention, there is provided a channel analyzing apparatus using a transmitter identification signal, and the apparatus includes a reference signal generating unit to generate a reference signal, a correlation unit to correlate a received signal and the reference signal to calculate a correlation value, an interpolation unit to interpolate the calculated correlation value, and an analysis unit to analyze the received signal using the interpolated correlation value.

According to an aspect of the present invention, there is provided a channel analyzing method using a transmitter identification signal, and the method includes generating a reference signal, correlating a received signal and the reference signal, interpolating the correlation value generated by the correlating, and analyzing the received signal using the interpolated correlation value.

Additional aspects, features, and/or advantages of the invention will be set forth in part in the description which follows and, in part, will be apparent from the description, or may be learned by practice of the invention.

### EFFECT

According to embodiments, a correlation value may be calculated by correlating a received signal and a reference signal, and a feature of a received signal may be accurately analyzed, using a maximum correlation value among adjacent correlation values and a timing of the maximum correlation value, even when a synchronization error is incurred.

Therefore, a feature of a signal received in a different timing from a VSB symbol timing or a sampling timing may be accurately analyzed.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a conventional transmitter identification signal analysis apparatus;

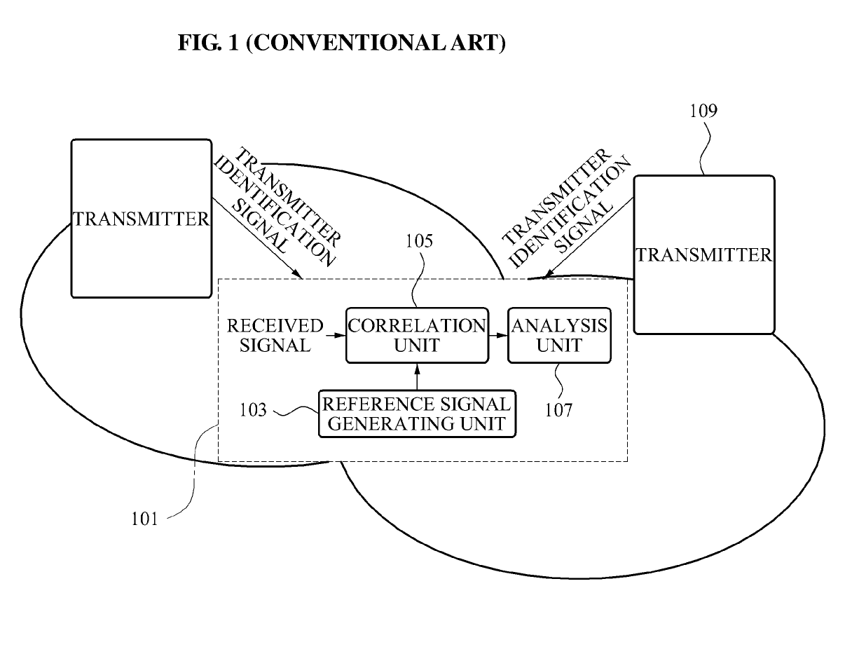

FIG. 2 is a diagram illustrating a correlation output signal generated when a synchronization error is not incurred in a conventional transmitter identification signal analysis apparatus;

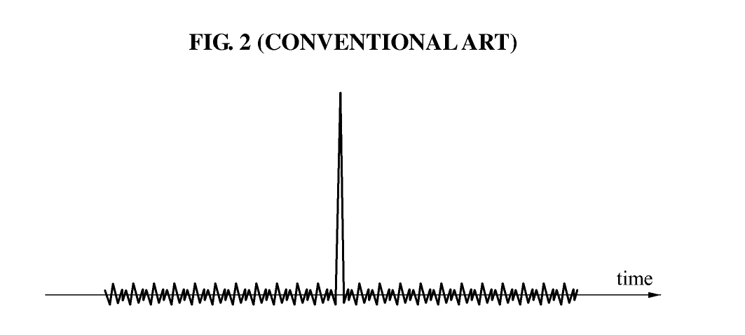

FIG. 3 is a diagram illustrating a magnified peak of FIG. 2;

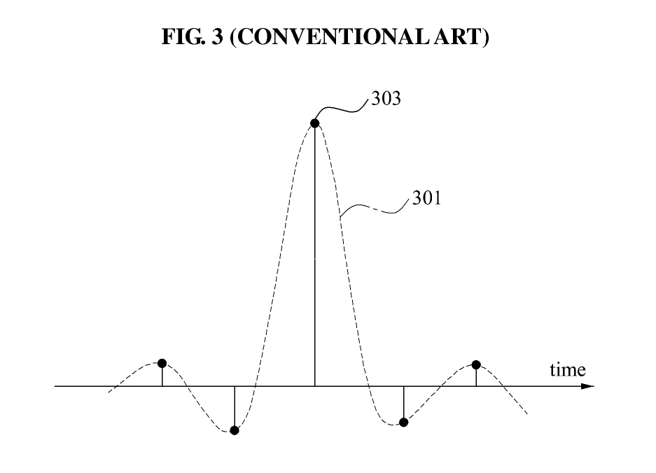

FIG. 4 is a diagram illustrating a correlation output signal generated when a synchronization error is incurred in a conventional transmitter identification signal analysis apparatus;

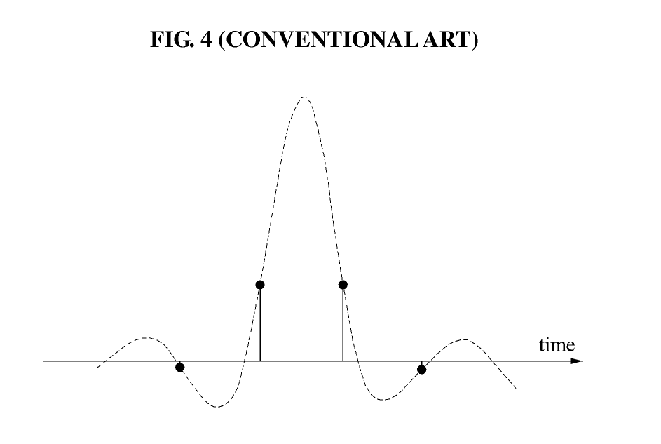

FIG. 5 is a diagram illustrating a configuration of a channel analysis apparatus using a transmitter identification signal according to an embodiment of the present invention;

FIG. 6 is a diagram illustrating an interpolated output signal generated by interpolating a correlation output signal in a channel analysis apparatus using a transmitter identification signal according to an embodiment of the present invention; and

FIG. 7 is a flowchart illustrating a channel analysis method using a transmitter identification signal according to an embodiment of the present invention.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

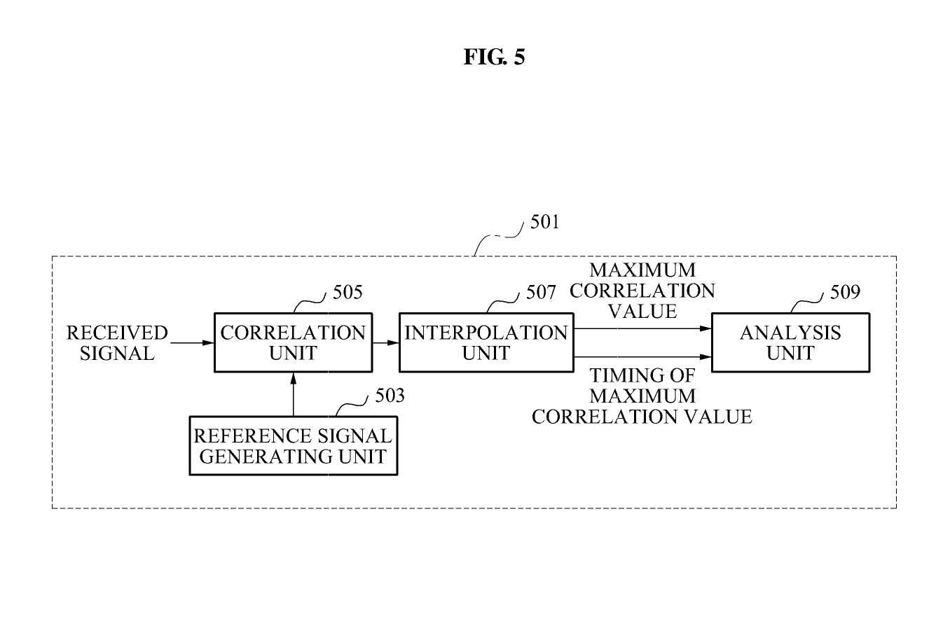

FIG. 5 illustrates a configuration of a channel analysis apparatus 501 using a transmitter identification signal according to an embodiment of the present invention.

Referring to FIG. 5, the channel analysis apparatus 501 using the transmitter identification signal according to an embodiment of the present invention may include a reference signal generating unit 503, a correlation unit 505, an interpolation unit 507, and an analysis unit 509.

The reference signal generating unit 503 may generate a reference signal.

The correlation unit 505 may receive a signal, and may correlate the received signal and the reference signal to calculate a correlation value. In this case, the correlation unit 505 may receive a plurality of signals, and each of the received signals may include a transmitter identification signal.

The correlation unit 505 may discrete-correlate the received signal and the reference signal.

The interpolation unit 507 may interpolate the correlation value based on an interpolation scheme.

Specifically, the interpolation unit 507 may determine a maximum correlation value among adjacent correlation values, may determine a timing of a maximum correlation value, and may interpolate a correlation value associated with the received signal using the maximum correlation value, at the determined timing.

The analysis unit 509 may analyze the received signal based on the interpolated correlation value. The analysis unit 509 may analyze the received signal based on the interpolated correlation value and the maximum correlation value.

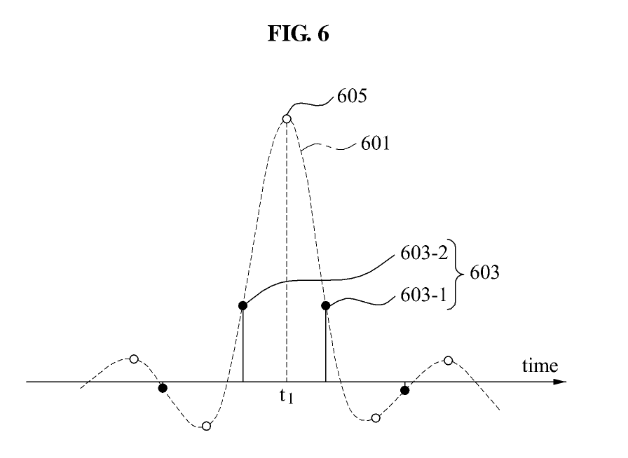

FIG. 6 illustrates an interpolated output signal generated by interpolating a correlation output signal in a channel analysis apparatus using a transmitter identification signal according to an embodiment of the present invention.

Referring to FIG. 6, a dotted curve 601 indicates a theoretical correlation feature, and a point 603 connected to a line indicates a discrete correlation value based on a time interval where a transmitter identification signal analysis apparatus calculates a correlation value. In this case, the time interval of a discrete correlation value may be an operating sampling interval of the transmitter identification signal analysis apparatus or a length of a symbol of a received signal.

The channel analysis apparatus using the transmitter identification signal according to an embodiment of the present invention may determine a maximum correlation value 605 among adjacent correlation values 603-1 and 603-2, may determine a timing t₁ of the maximum correlation value, and may interpolate a correlation value associated with the received signal using the maximum correlation value 605 at the timing t₁ of the maximum correlation value.

According to embodiments, a correlation value may be calculated by correlating a received signal and a reference signal, and a feature of the received signal may be accurately analyzed when a synchronization error exists, based on a maximum correlation value among adjacent correlation values and a timing of the maximum correlation value.

Therefore, a feature of a signal received in a different timing from a VSB symbol timing or a sampling timing may be accurately analyzed.

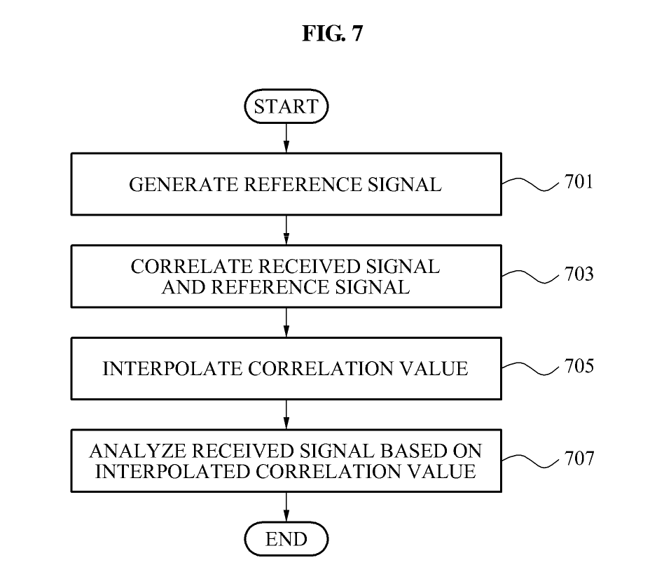

FIG. 7 illustrates a channel analysis method using a transmitter identification signal according to an embodiment of the present invention.

Referring to FIG. 7, a channel analysis apparatus using a transmitter identification signal generates a reference signal in operation 701.

Subsequently, the channel analysis apparatus using the transmitter identification signal correlates a received signal and the reference signal in operation 703.

The channel analysis apparatus using the transmitter identification signal may receive the signal and correlate the received signal and the reference signal to calculate a correlation value. In this case, the channel analysis apparatus using the transmitter identification signal may receive a plurality of signals, and each of the received signals may include a transmitter identification signal.

The channel analysis apparatus using the transmitter identification signal may discrete-correlate the received signal and the reference signal.

Subsequently, the channel analysis apparatus using the transmitter identification signal may interpolate the generated correlation value in operation 705.

The channel analysis apparatus using the transmitter identification signal may determine a maximum value among adjacent correlation values, may determine a timing of the maximum correlation value, and may interpolate a correlation value associated with the received signal using the maximum correlation value, at the determined timing.

Subsequently, the channel analysis apparatus using the transmitter identification signal analyzes the received signal based on the interpolated correlation value in operation 707.

The channel analysis apparatus using the transmitter identification signal may analyze the received signal based on the interpolated correlation value and the maximum correlation value.

The method according to the above-described embodiments of the present invention may be recorded in non-transitory computer readable media including program instructions to implement various operations embodied by a computer. The media may also include, alone or in combination with the program instructions, data files, data structures, and the like. Examples of non-transitory computer readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus of analyzing a channel using a transmitter identification signal, the apparatus comprising:
a reference signal generating unit to generate a reference signal;
a correlation unit to correlate a received signal and the reference signal to calculate a correlation value;
an interpolation unit to interpolate the calculated correlation value; and
an analysis unit to analyze the received signal using the interpolated correlation value.

2. The apparatus of claim 1, wherein the correlation unit discrete-correlates the received signal and the reference signal.

3. The apparatus of claim 1, wherein the interpolation unit determines a maximum correlation value among adjacent correlation values, determines a timing of the maximum correlation value, and interpolates a correlation value associated with the received signal using the maximum correlation value, at the determined timing.

4. The apparatus of claim 3, wherein the analysis unit analyzes the received signal based on the maximum correlation value.

5. The apparatus of claim 1, wherein the correlation unit receives a plurality of signals, and each of the received signals includes a transmitter identification signal.

6. A method of analyzing a channel using a transmitter identification signal, the method comprising:
generating a reference signal;
correlating a received signal and the reference signal;
interpolating the correlation value generated by the correlating; and
analyzing the received signal using the interpolated correlation value.

7. The method of claim 6, wherein the correlating comprises discrete-correlating the received signal and the reference signal.

8. The method of claim 6, wherein the interpolating comprises determining a maximum correlation value among adjacent correlation values, determining a timing of the maximum correlation value, and interpolating a correlation value associated with the received signal using the maximum correlation value, at the determined timing.

9. The method of claim 8, wherein the analyzing comprises analyzing the received signal based on the maximum correlation value.

10. The method of claim 6, further comprising:
receiving a plurality of signals, wherein each of the received signals includes a transmitter identification signal.
